(19) United States
(12) Patent Application Publication
(10) Pub. No.: US 2010/0097324 A1
(43) Pub. Date: Apr. 22, 2010

(54) Parental Controls Based on Touchscreen Input

(75) Inventors: Douglas Miles Anson, Dripping Springs, TX (US); Roy William Stedman, Austin, TX (US)

Correspondence Address: Baker Botts L.L.P, 910 Louisiana Street, One Shell Plaza, HOUSTON, TX, 77002, US

(73) Assignee: DELL PRODUCTS L.P., Round Rock, TX (US)

(21) Appl. No.: 12/254,639

(22) Filed: Oct. 20, 2008

(51) Int. Cl. G06F 3/041

(52) U.S. Cl. 345/173

(57) ABSTRACT

A method for controlling user access in an information handling system is provided. Touchscreen signals indicating multiple simultaneous touch points on a touchscreen by an information handling system user are received. The received touchscreen signals are analyzed, and an authorization determination regarding the particular user is made based at least on the analysis of the touchscreen signals. The particular user's access to one or more aspects of the information handling system is controlled based at least on the authorization determination regarding the particular user.

### TECHNICAL FIELD

The present disclosure relates to information handling systems, and more particularly, to parental controls for accessing information handling system features based on touchscreen input from a user.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as, but not limited to, financial transaction processing, airline reservations, enterprise data storage, or global communications. In addition, information handling systems may include a variety of hardware and software components that may be configured to process, store, and communicate information and may include one or more computer systems, data storage systems, and networking systems.

Controlling user access to particular aspects of an information handling system (e.g., access to login to the information handling system, or access to particular applications, features, data, web sites, etc.) is a relevant concern for system administrators. In addition, parents or adults often wish to control children's access to particular aspects of an information handling system, e.g., applications that may include adult or private content.

Parental controls for information handling system (e.g., digital television services, computer and video games, or computer software used to access the Internet) typically allow a parent or other adult to monitor or limit what a child can see or do and/or time-limit these activities. These controls may allow for the blocking of television stations using V-Chip technology, the removal of gore from computer games, the blocking of various websites, such as those containing pornography, or the automatic censoring of swearing.

### SUMMARY

In accordance with certain embodiments of the present disclosure, a method for controlling user access in an information handling system is provided. The method includes: receiving touchscreen signals indicating multiple simultaneous touch points on a touchscreen by a particular user of an information handling system; analyzing the received touchscreen signals; making an authorization determination regarding the particular user based at least on the analysis of the touchscreen signals; and controlling the particular user's access to one or more aspects of the information handling system based at least on the authorization determination regarding the particular user.

In accordance with certain embodiments of the present disclosure, computer-executable instructions for controlling user access in an information handling system are stored in a tangible computer readable medium and executable by a processor to: receive touchscreen signals indicating multiple simultaneous touch points on a touchscreen by a particular user of an information handling system; analyze the received touchscreen signals; make an authorization determination regarding the particular user based at least on the analysis of the touchscreen signals; and control the particular user's access to one or more aspects of the information handling system based at least on the authorization determination regarding the particular user.

In accordance with certain embodiments of the present disclosure, an information handling system configured to control user access based at least on user input to a touchscreen is provided. The information handling system includes a touchscreen configured to receive input from a user and generate corresponding touchscreen signals, a processor, a memory communicatively coupled to the processor, and computer-executable instructions for controlling user access in an information handling system, the instructions being stored in the memory and executable by the processor. The computer-executable instructions are operable to: receive touchscreen signals indicating multiple simultaneous touch points on the touchscreen by the user of an information handling system; analyze the received touchscreen signals; make an authorization determination regarding the user based at least on the analysis of the touchscreen signals; and control the user's access to one or more aspects of the information handling system based at least on the authorization determination regarding the user.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for controlling user access in an information handling system, in accordance with certain embodiments of the present disclosure;

FIGS. 2A and 2B illustrate example target images displayed on a touchscreen for authorizing a user, according to certain embodiments of the present disclosure;

FIG. 3 illustrates a flow chart of an example method for making an authorization determination for a user, using the target image shown in FIG. 2A, according to one embodiment; and

FIG. 4 illustrates a flow chart of an example method for making an authorization determination for a user, using the target image shown in FIG. 2B, according to one embodiment.

### DETAILED DESCRIPTION

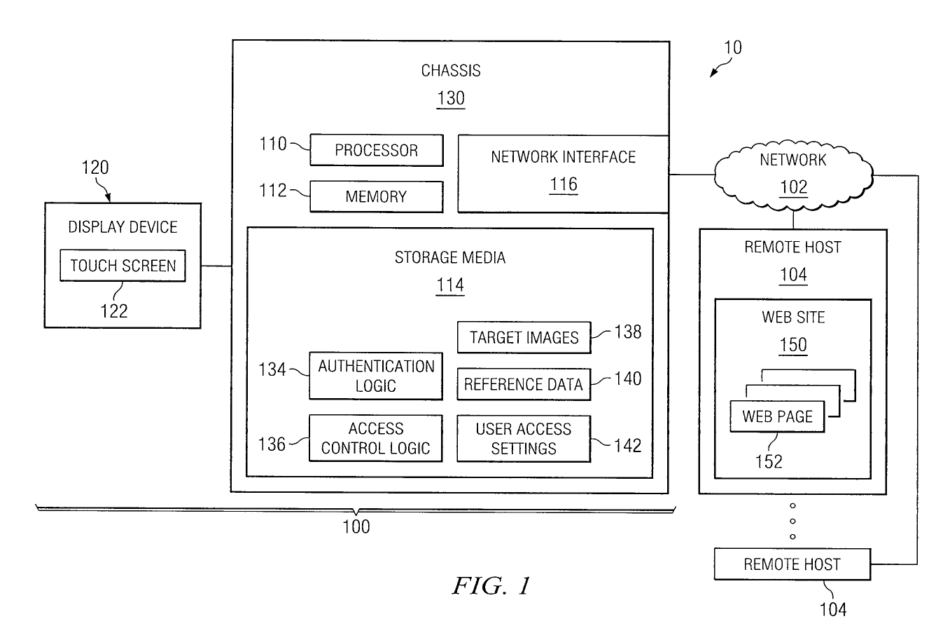

Preferred embodiments and their advantages are best understood by reference to FIGS. 1-4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a block diagram of an example system 10 for controlling user access for an information handling system 100, in accordance with certain embodiments of the present disclosure. As depicted in FIG. 1, system 10 may include an information handling system 100, a network 102, and one or more remote hosts 104 connected to information handling system 100 via network 102.

Information handling system 100 may generally be operable to receive data from and/or communicate data to one or more remote hosts 104 via network 102. In certain embodiments, information handling system 100 may be a personal computer (e.g., a desktop computer or a portable computer). In another embodiment, information handling system 100 may be a server. In another embodiment, information handling system 100 may be a networked terminal or a stand-alone machine, e.g., an ATM, kiosk, ticket vending/dispensing machine, video game machine, door security system, etc.

As depicted in FIG. 1, information handling system 100 may include a processor 110, a memory 112 communicatively coupled to processor 110, storage media 114 communicatively coupled to processor 110, a network interface 116 communicatively coupled to processor 110, a display device 120 including a touchscreen 122, and/or any other suitable information handling system components.

Is some embodiments (e.g., certain desktop computer systems or server configurations), processor 110, memory 112, storage media 114, and network interface 116 may be located in a chassis 130 (e.g., a tower or blade server housing), and display device 120 may be connected to chassis by a cable (e.g., a DVI or VGA cable) or other wireline or wireless connection. FIG. 1 illustrates an example of such configuration. In other embodiments (e.g., certain desktop computer systems, an ATM, kiosk, ticket vending/dispensing machine, video game machine, etc.), display device 120 may be integral with chassis 130.

Processor 110 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 110 may interpret and/or execute program instructions and/or process data stored in memory 112, storage media 114 and/or another component of information handling system 100.

Memory 112 may be communicatively coupled to processor 110 and may include any system, device, or apparatus configured to retain program instructions and/or data for a period of time (e.g., computer-readable media). Memory 112 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 100 is turned off.

Storage media 114 may include computer-readable media (e.g., hard disk drive, floppy disk drive, CD-ROM, and/or other type of rotating storage media, flash memory, EEPROM, and/or other type of solid state storage media) and may be generally operable to store data and/or programs (e.g., one or more operating systems and/or one or more application programs).

In particular, storage media 114 may store authorization logic 134, access control logic 136, target images 138, reference data 140, and user access settings 142. Authorization logic 134 and access control logic 136 may be executable by processor 110 (and/or other processing resources of system 100) to provide any of the various functionality discussed herein. Authorization logic 134 is generally operable to manage the authorization of various users of information handling system 10 based at least on touch signals generated when such users contact touchscreen 122 (e.g., in response to a user prompt to touch certain areas on touchscreen 122 or to place the user's hand against touchscreen 122). Access control logic 136 is generally operable to control particular users' access to one or more aspects of the information handling system based at least on the authorization determinations regarding such users, as determined by authorization logic 134. For example, access control logic 136 may control a particular user's access to particular local applications and/or remote web sites or web pages based on whether authorization logic 134 determines that the user is a child or an adult. The various functions provided by authorization logic 134 and access control logic 136, as well as target images 138, reference data 140, and user access settings 142, are discussed below in greater detail.

Network interface 116 may include any suitable system, apparatus, or device operable to serve as an interface between information handling system 100 and network 102. Network interface 116 may enable information handling system 100 to communicate over network 102 using any suitable transmission protocol and/or standard, including without limitation all transmission protocols and/or standards enumerated below with respect to the discussion of network 102. In certain embodiments, network interface 116 may be configured with hardware, software, and/or firmware to allow its associated information handling system 100 to remotely boot from a computer-readable medium remote from information handling system 100 (e.g., a computer-readable medium coupled to network interface 116 via network 102).

Network 102 may be a network and/or fabric configured to communicatively couple information handling system 100 with one or more remote hosts 104 and/or other remote information handling systems. Network 102 may include a communication infrastructure, which provides physical connections, and a management layer, which organizes the physical connections, information handling system 102, access controller 112, and provisioning server 122. In the same or alternative embodiments, network 102 may allow block I/O services and/or file access services to network-attached computer-readable media. Network 102 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data).

A remote host 104 may include any information handling system that hosts content or data accessible to information handling system 100. For example, a remote host 104 may be a web server that hosts one or more web sites 150, each of which may include one or more web pages 152. The web server may receive requests (e.g., HyperText Transport Protocol (HTTP) requests) from a web browser application hosted on information handling system 100, and serve web pages 152 to information handling system 100 for display on display device 120. Such web pages 152 may include content such as HyperText Markup Language (HTML) documents and linked objects (images, advertisements, etc.), for example. As another example, a remote host 104 may comprise a file server storing files (e.g., MP3 files) that may be downloaded or copied to information handling system 100 via network 102.

As shown in FIG. 1, display device 120 may include touchscreen 122. Touchscreen 122 is a display that can detect the presence and location of a touch within a display area. Touchscreen 122 may use any type of touchscreen technology. For example, touchscreen 122 may be a resistive touchscreen, such as a four-, five-, or eight-wire resistive panel; an acoustic wave or surface acoustic wave (SAW) touchscreen, a capacitive touchscreen; an infrared (IR) touchscreen; a strain gauge touchscreen; an optical imaging touchscreen; a dispersive signal type touchscreen; an acoustic pulse recognition touchscreen; an optical touchscreen based on frustrated total internal reflection; or any other type technology for detecting a touch within a display area.

In some embodiments, touchscreen 122 is a multi-touchscreen capable of sensing multiple simultaneous points of contact. In addition, touchscreen 122 may include any suitable electronics operable to generate signals in response to a touch on the display and communicate such signals to one or more components of information handling system 100. For example, touchscreen 122 may include any suitable electronics operable to generate and communicate touch signals to processor 110 for processing by authorization logic 134.

Touchscreen 122 may be able to receive touch input from a human (e.g., a finger or hand) and/or from non-human objects (e.g., a stylus, wand, pointer, etc.). In some embodiments, touchscreen 122 may be capable of distinguishing human from non-human touches. For example, touchscreen 122 may be a capacitive touchscreen activated by electrical charge (e.g., from a finger). Such capacitive touchscreens may be activated by a human touch, but not by inanimate item such as a stylus or pen. Such a touchscreen 122 may be used to prevent unauthorized users (e.g., children) from tricking the authentication system by using inanimate objects in place of the user's finger or hand (e.g., using pens or other objects to touch target images on the screen that the user could not reach with their hand(s)).

In some embodiments, touchscreen 122 may detect a touch based on proximity, without actual physical contact with the display screen. Thus, as used herein, the term “touch” refers to any physical contact or near-contact of an object (human or non-human) with touchscreen 122 that is detected by touchscreen 122.

As discussed above, authorization logic 134 is generally operable to manage the authorization of various users of information handling system 10 based at least on touch signals generated when such users contact touchscreen 122 (e.g., in response to a user prompt to touch certain areas on touchscreen 122 or to place the user's hand against touchscreen 122). Authorization logic 134 may be executed by processor 110 and/or any other suitable processing resources for performing any various functions associated with authorizing users of information handling system 10.

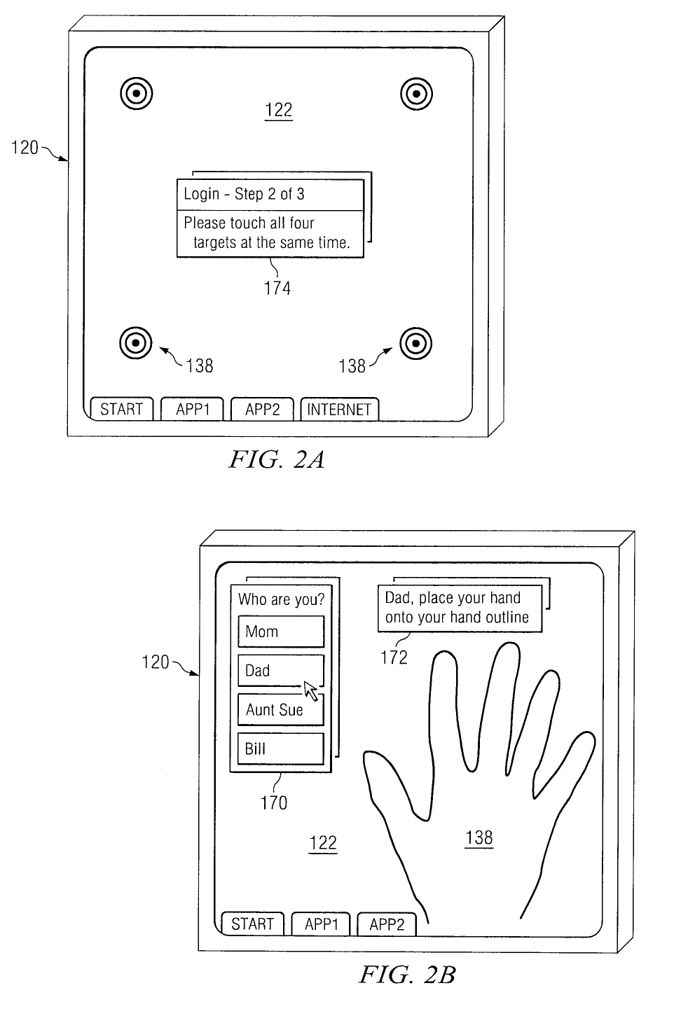

For example, authorization logic 134 may be operable to display one or more target images 138 on touchscreen 122. Target images 138 may include images for a user to touch in order to authenticate the user. For example, a target image 138 may include multiple touch targets (e.g., shapes or icons) displayed at different locations on the screen simultaneously, e.g., as shown in FIG. 2A. The multiple touch targets may be spaced apart at particular distances such that a user with small hands (e.g., a child) may not be able to touch all of the multiple touch targets simultaneously.

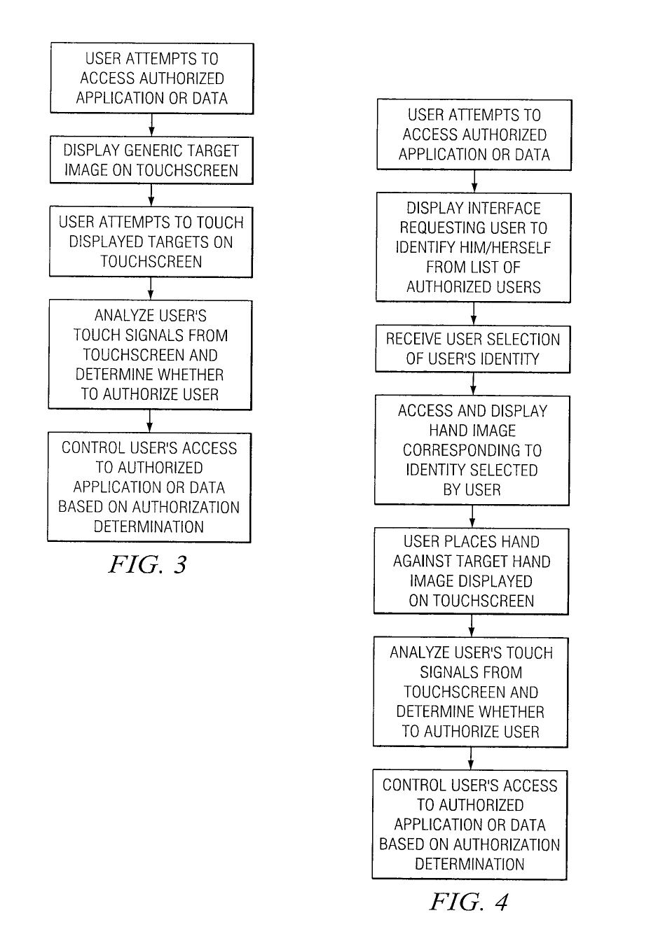

As another example, a target image 138 may include an image or an outline of one or two hands, e.g., as shown in FIG. 2B. The displayed hand image(s) may be generic hand images (e.g., average adult sized). Alternatively, the displayed hand image(s) may be specific to a particular user. For example, as discussed below with reference to method 200 of FIG. 3, authorization logic 134 may display an interface allowing a user to select their identity from a list of authorized users, each having a hand image previously stored as reference data 140. When the user selects a particular authorized user, authorization logic 134 may access the stored hand image for the selected authorized user, and display that hand image on touchscreen 122. Authorization logic 134 may then direct the user to place his or her hand on the displayed authorized hand image.

Target image 138 may include any other various images for a user to touch in order to make an authorization determination regarding the user.

In some embodiments or instances, authorization logic 134 may display corresponding instructions along with target images 138. For example, authorization logic 134 may display instructions directing the user to touch one or more target images 138 displayed on touchscreen 122 and/or explaining how to touch such images. Example instructions may be “Please touch the four circles displayed on the screen with your fingertips, and hold for 3 seconds,” “Please place your right hand gently onto the screen within the indicated box, with your fingers spread apart,” or “Please place your left hand onto the image of the hand displayed on the screen, and press the ‘Enter’ key.”

Authorization logic 134 may display target images 138 and/or corresponding instructions during any user authorization event, which may be defined as event in which a user is attempting to login or access any application, feature, or other data that has been identified as requiring authorized access. Example user authorization events may include booting up or logging in to information handling system 10, a user attempt to access a particular application (e.g., a web browser or game application), or a user attempt to access a particular web site 150 or web page 152.

User access settings 142 may define various actions that trigger user authorization events. User access settings 142 may be defined automatically (e.g., by an access control application) or manually, e.g., by an administrator or, in certain implementations, by a parent or adult wishing to identify particular applications, features, data, etc. as requiring authorized access. In some embodiments, access control logic 136 may provide an interface via display device 120 allowing an administrator, parent, adult, etc. to set and/or adjust user access settings 142.

Authorization logic 134 is also operable to analyze user touch signals generated when users touch touchscreen 122, and make authorization determinations for such users based on such user touch signals, e.g., whether a particular user is identified as a known authorized user, or whether a particular user is an adult or a child.

In some implementations, authorization logic 134 may analyze whether a user has simultaneously touched all of the required targets in a target image 138. For example, if target image 138 includes four target shapes or icons, authorization logic 134 may analyze touch signals from touchscreen 122 to determine whether the user has touched all four targets simultaneously—if yes, the user is authorized; if not, the user is not authorized.

In other implementations, authorization logic 134 may compare user touch signals received from touchscreen 122 with reference data 140 in order to make an authorization determination. Reference data 140 may include, for example, reference data or thresholds for various physiological parameters or geometries. For example, reference data 140 may include an adult average value, a minimum adult value, a maximum adult value, and/or any other values corresponding to physiological parameters such as: palm width, palm length, palm size (area), finger length (for each finger), total hand length, total hand width, total hand size (area), distance from center of palm to end of finger, etc. As another example, reference data may include data regarding palm shape, finger shape, or hand shape (e.g., based on dimensions and relative locations of various touch points associated with such body parts).

Minimum and/or maximum adult values for particular physiological parameters or geometries may represent threshold values for such parameters or geometries, such that is authorization logic 134 may determine whether a user is an adult by comparing physiological parameters or geometries of the user (based on user touch signals from touchscreen 122) exceed such threshold values. For example, reference data 140 may define a minimum adult palm with of 2.5 inches and a minimum adult palm with of 4.5 inches. If authorization logic 134 receives touch signals from touchscreen 122 for a particular user, and determines the user's palm width to be below 2.5 inches (e.g., a child's hand) or above 4.5 inches (e.g., a child attempting to trick the system), authorization logic 134 ay determine that the user is a child, and deny authorization for the user.

As another example, authorization logic 134 may add a predetermined margin (e.g., 40%) on one or both sides of an average adult value for a parameter (e.g., hand length) to define minimum and/or maximum thresholds for that parameter.

The various values stored as reference data 140 (e.g., adult average values, minimum adult values, maximum adult values, etc.) may be determined based on statistical data (e.g., minimum adult values may represent a 5th percentile in an adult population), or may be set and/or adjusted by an authorized user (e.g., an administrator or a parent).

Reference data 140 may also include, for example, reference data for various physiological parameters or geometries of particular users of information handling system 10. For example, reference data 140 may include a user profile for each authorized user of information handling system 10. A user profile for a particular user may include pre-recorded data for any physiological parameters of the user, e.g., any of the parameters discussed above. Such data for each authorized user may be pre-recorded by having the authorized user touch touchscreen 122 in various manners in order to measure the various touch point locations, dimensions, and geometries associated with that authorized user's physiology.

As discussed above, access control logic 136 is generally operable to control particular users' access to one or more aspects of the information handling system based at least on the authorization determinations regarding such users made by authorization logic 134. For example, access control logic 136 may control a particular user's access to particular local applications and/or remote web sites or web pages based on whether authorization logic 134 determines that the user is a child or an adult.

Access control logic 136 may control user access based on determinations made by authorization logic 134 and user access settings 142 for the particular application, feature, data, etc. that the user is attempting to access. User access settings 142 may define authentication requirements for particular applications, actions, data access, etc. For example, user access settings 142 may define that a particular application (e.g., a web browser) can only be accessed by adults, or by particular authorized users.

As discussed above, user access settings 142 may be defined automatically (e.g., by an access control application) or manually, e.g., by an administrator or, in certain implementations, by a parent or adult wishing to identify particular applications, features, data, etc. as requiring authorized access. In some embodiments, access control logic 136 may provide an interface via display device 120 allowing an administrator, parent, adult, etc. to set and/or adjust user access settings 142.

FIGS. 2A and 2B illustrate two example target images 138 displayed on a touchscreen 122 for authorizing a user, according to certain embodiments of the present disclosure. FIG. 2A illustrates an example of a generic target image 138 that may be displayed during an authorization event. The generic target image 138 includes four target touch points and a pop-up window directing the user to “Please touch all four targets at the same time.”

FIG. 2B illustrates an example of a user-specific target image 138 that may be displayed during an authorization event. During the authorization event, a pop-up window 170 displays a list of authorized users and instructs the user to identify him or herself from the list. When the user selects one of the authorized users—in this example, the user selects “Dad,” authorization logic 134 accesses a user profile corresponding to Dad (i.e., reference data 140). Authorization logic 134 then displays a target image 138 of Dad's right hand, along with the pop-up windrow 172 instructing the user: “Dad, place your hand onto your hand outline.” The hand image may be a replica of a previously recorded hand image for Dad.

FIG. 3 illustrates a flow chart of an example method 200 for making an authorization determination for a user, using the example generic target image 138 shown in FIG. 2A, according to one embodiment.

At step 202, a user of information handling system 10 attempts to access an application or data previously flagged as requiring authorized access. For example, the user may be attempting to access a web site or application that may include adult content.

In response, at step 204, authorization logic 134 displays generic target image 138 shown in FIG. 2A on touchscreen 122, along with pop-up box 174.

At step 206, the user attempts to touch the four targets in target image 138. As the user touches touchscreen 122, touchscreen 122 generates and communicates corresponding touch signals to processor 110 (or other processing resources) for processing by authorization logic 134.

At step 208, authorization logic 134 analyzes the touch signals from touchscreen 122 and determines whether to authorize the user. For example, authorization logic 134 may determine whether the user touched all four targets displayed on touchscreen 122. In one example, authorization logic 134 may determine to authorize the user only if all four targets were touched simultaneously. In another example, authorization logic 134 may determine to authorize the user only if at least three of the four targets were touched simultaneously. In some embodiments, authorization logic 134 may be capable of distinguishing between human touches and non-human touches, such that an attempt to trick the system, e.g., by using objects to touch one or more of the targets, may be detected.

At step 210, access control logic 136 may control the user's access to the application or data that triggered the authentication event, based at least on the determination made by authorization logic 134 at step 208. Access control logic 136 may control the user's access based solely on the determination made by authorization logic 134, or based on the determination made by authorization logic 134 in combination with additional input (e.g., a password entered by the user).

FIG. 4 illustrates a flow chart of an example method 250 for making an authorization determination for a user, using the example user-specific target image 138 shown in FIG. 2B, according to one embodiment.

At step 252, a user of information handling system 10 attempts to access an application or data previously flagged as requiring authorized access. For example, the user may be attempting to access a web site or application that may include adult content.

In response, at step 254, authorization logic 134 displays pop-up window 170 asking the user to identify him or herself from a list of authorized users. At step 256, the user selects one of the authorized users from the list in pop-up window 170 (e.g., by clicking with a mouse or trackpad).

In response, at step 258, authorization logic 134 accesses a hand image corresponding to the selected user from storage (i.e., reference data 140) and displays the hand image on touchscreen 122 as target image 138, along with pop-up window 172 directing the user to place his or her hand against the displayed hand image.

At step 260, the user places his or her hand against the hand image on touchscreen 122. As the user touches touchscreen 122, touchscreen 122 generates and communicates corresponding touch signals to processor 110 (or other processing resources) for processing by authorization logic 134.

At step 262, authorization logic 134 analyzes the touch signals from touchscreen 122 and determines whether to authorize the user. For example, authorization logic 134 may compare one or more touch points on touchscreen 122 with the target hand image. Authorization logic 134 may use any known or suitable algorithms for comparing the user's touch points with the target hand image to determine whether the user's touch points sufficiently correspond to the target hand image, based on any suitable threshold levels. For example, authorization logic 134 may identify physiological features of the user (e.g., the user's palm and each finger) based on the user's touch points on touchscreen 122, determine measurements or geometries for such physiological features, and compare such measurements or geometries with corresponding measurements or geometries defined in the stored hand image for the authorized user. If the measurements or geometries of the user's touch points sufficiently match those of the stored hand image, authorization logic 134 may determine to authorize the user. Otherwise, authorization logic 134 may refuse to authorize the user.

At step 264, access control logic 136 may control the user's access to the application or data that triggered the authentication event, based at least on the determination made by authorization logic 134 at step 208. Access control logic 136 may control the user's access based solely on the determination made by authorization logic 134, or based on the determination made by authorization logic 134 in combination with additional input (e.g., a password entered by the user).

Although the present disclosure has been described in detail, it should be understood that various changes, substitutions, and alterations can be made hereto without departing from the spirit and the scope of the invention as defined by the appended claims.

What is claimed is:

1. A method for controlling user access in an information handling system, comprising:
receiving touchscreen signals indicating multiple simultaneous touch points on a touchscreen by a particular user of an information handling system;
analyzing the received touchscreen signals;
making an authorization determination regarding the particular user based at least on the analysis of the touchscreen signals; and
controlling the particular user's access to one or more aspects of the information handling system based at least on the authorization determination regarding the particular user.

2. The method of claim 1, wherein:
analyzing the received touchscreen signals comprises determining whether the user is a child;
making an authorization determination regarding the particular user comprises not authorizing the user if the user is determined to be child based on the analysis of the touchscreen signals.

3. The method of claim 1, wherein controlling the particular user's access to one or more aspects of the information handling system comprises controlling the particular user's access to one or more web sites.

4. The method of claim 1, wherein controlling the particular user's access to one or more aspects of the information handling system comprises controlling the particular user's access to one or more local applications of the information handling system.

5. The method of claim 1, further comprising:
displaying an image on the touchscreen indicating multiple target touch locations on the touchscreen for the particular user to physically contact;
wherein analyzing the received touchscreen signals comprises comparing the multiple simultaneous touch points with the multiple target touch locations indicated in the displayed image; and
making an authorization determination regarding the particular user based at least on the comparison of the multiple simultaneous touch points with the multiple target touch locations.

6. The method of claim 5, wherein:
analyzing the received touchscreen signals further comprises determining whether each of the multiple target touch locations is touched by the particular user; and
making an authorization determination regarding the particular user based at least on the determination of whether all of the multiple target touch locations are simultaneously touched by the particular user.

7. The method of claim 1, wherein analyzing the received touchscreen signals comprises:
determining a number of the multiple target touch locations simultaneously touched by the particular user; and
determining whether the number of multiple target touch locations simultaneously touched by the particular user meets a predetermined threshold number.

8. The method of claim 1, wherein analyzing the received touchscreen signals further comprises:
determining, based on the multiple simultaneous touch points on the touchscreen, at least one physical characteristic of the particular user from a group of physical characteristics consisting of:
a size of the particular user's palm;
a shape of the particular user's palm;
a length of one or more of the particular user's fingers;
a size of the particular user's hand; and
a shape of the particular user's hand; and
comparing the one or more physical characteristics to one or more corresponding reference characteristics.

9. The method of claim 1, wherein analyzing the received touchscreen signals comprises determining a location of the particular user's palm on the touchscreen.

10. The method of claim 1, wherein analyzing the received touchscreen signals comprises determining a finger length of the particular user.

11. The method of claim 1, wherein analyzing the received touchscreen signals further comprises determining a hand print size for the particular user.

12. The method of claim 1, wherein:
analyzing the received touchscreen signals comprises:
comparing the multiple simultaneous touch points on the touchscreen with one or more authorized reference data sets, each authorized reference data set corresponding to an authorized user; and
determining whether the particular user is an authorized user based at least on the comparison of the multiple simultaneous touch points with the one or more authorized reference data sets; and
making an authorization determination regarding the user comprises making an authorization determination regarding the user based at least on whether the particular user is determined to be an authorized user.

13. Computer-executable instructions for controlling user access in an information handling system, the instructions stored in a tangible computer readable medium and executable by a processor to:
receive touchscreen signals indicating multiple simultaneous touch points on a touchscreen by a particular user of an information handling system;
analyze the received touchscreen signals;
make an authorization determination regarding the particular user based at least on the analysis of the touchscreen signals; and
control the particular user's access to one or more aspects of the information handling system based at least on the authorization determination regarding the particular user.

14. The computer-executable instructions of claim 13, further operable to:
analyze the received touchscreen signals comprises determining whether the user is a child; and
make an authorization determination regarding the particular user comprises not authorizing the user if the user is determined to be child based on the analysis of the touchscreen signals.

15. The computer-executable instructions of claim 13, wherein controlling the particular user's access to one or more aspects of the information handling system comprises controlling the particular user's access to one or more web sites.

16. The computer-executable instructions of claim 13, further operable to:
display an image on the touchscreen indicating multiple target touch locations on the touchscreen for the particular user to physically contact;
compare the multiple simultaneous touch points with the multiple target touch locations indicated in the displayed image; and
make an authorization determination regarding the particular user based at least on the comparison of the multiple simultaneous touch points with the multiple target touch locations.

17. The computer-executable instructions of claim 16, wherein:
analyzing the received touchscreen signals further comprises determining whether each of the multiple target touch locations is touched by the particular user; and
making an authorization determination regarding the particular user based at least on the determination of whether all of the multiple target touch locations are simultaneously touched by the particular user.

18. The computer-executable instructions of claim 13, wherein analyzing the received touchscreen signals further comprises:
determining, based on the multiple simultaneous touch points on the touchscreen, at least one physical characteristic of the particular user from a group of physical characteristics consisting of:
a size of the particular user's palm;
a shape of the particular user's palm;
a length of one or more of the particular user's fingers;
a size of the particular user's hand; and
a shape of the particular user's hand; and
comparing the one or more physical characteristics to one or more corresponding reference characteristics.

19. The computer-executable instructions of claim 13, wherein:
analyzing the received touchscreen signals comprises:
comparing the multiple simultaneous touch points on the touchscreen with one or more authorized reference data sets, each authorized reference data set corresponding to an authorized user; and
determining whether the particular user is an authorized user based at least on the comparison of the multiple simultaneous touch points with the one or more authorized reference data sets; and
making an authorization determination regarding the user comprises making an authorization determination regarding the user based at least on whether the particular user is determined to be an authorized user.

20. An information handling system configured to control user access based at least on user input to a touchscreen, comprising:
a touchscreen configured to receive input from a user and generate corresponding touchscreen signals;
a processor;
a memory communicatively coupled to the processor; and
computer-executable instructions for controlling user access in an information handling system, the instructions stored in the memory and executable by the processor to:
receive touchscreen signals indicating multiple simultaneous touch points on the touchscreen by the user of an information handling system;
analyze the received touchscreen signals;
make an authorization determination regarding the user based at least on the analysis of the touchscreen signals; and
control the user's access to one or more aspects of the information handling system based at least on the authorization determination regarding the user.
